(19) United States
(12) Patent Application Publication
(10) Pub. No.: US 2016/0321087 A1
(43) Pub. Date: Nov. 3, 2016

(54) METHODS OF INCREASING PROCESSING SPEED IN A PROCESSING SYSTEM THAT PERFORMS A NONLINEAR OPTIMIZATION ROUTINE

(71) Applicant: Toru YAMAZATO, Nishihara-cho (JP)

(72) Inventor: Toru YAMAZATO, Nishihara-cho (JP)

(21) Appl. No.: 15/136,314

(22) Filed: Apr. 22, 2016

(30) Foreign Application Priority Data
Apr. 30, 2015 (JP) 2015-093324

(51) Int. Cl. G06F 9/445; G06N 3/08; G06F 17/11; G06N 99/00

(52) U.S. Cl. CPC G06F 9/44505; G06N 99/005; G06N 3/08; G06F 17/11

(57) ABSTRACT

A method of increasing the processing speed of a computer having a computer processing unit that executes a nonlinear optimization routine is described. A favorable approximation of the derivative f′ (x+αd) at the critical point can be obtained by one differential calculation at each search step. As a result, when a large-scale nonlinear optimization problem requiring a large amount of calculations is processed, mₖ at each search step is reduced and consequently the calculation time T is reduced significantly.

### CROSS-REFERENCE TO RELATED APPLICATION

The present application is based on and claims the benefit of priority of Japanese Priority Application No. 2015-93324 filed on Apr. 30, 2015, and the entire contents of which are hereby incorporated by reference.

### FIELD

This disclosure relates to a processing system that has a processing program for executing a search process of determining a minimum or a maximum of a function f based on a line search method and that performs nonlinear optimization by causing a computer to operate using the processing program, to a nonlinear optimization method, and to a non-transitory computer readable medium recording the processing program thereon.

### BACKGROUND

Finding a set of optimal values is an important technology for machine learning systems including neural networks, solver systems such as numerical analysis system, operations research system, structural calculation system, design simulation system and analysis system of fluid, heat, electromagnetic waves, etc., and for many other computer systems such as control systems. In an area of artificial intelligence, the machine learning is applied to intelligent systems such as recognition systems for hand-written characters or human faces, and forecasting systems for demand of water or electrical power. The set of the values is considered as a vector. To find the optimal values for above systems, a computer system iteratively improves a given arbitrary vector x₀ consisting of the values to be optimized, step by step.

To optimize the values the systems typically evaluate a function f(x) that represents a degree of optimality or an error from the optimality of x. For example, f(x) represents a total profit according to x storing amounts of stocked items, or an error rate of a face recognition system using internal parameters stored in x. Then, the system iteratively changes x to maximize or minimize f(x) depending on what it represents. This process is called a nonlinear optimization. If a vector x* makes f(x*) a minimum or a maximum, then x* is a vector that holds optimal values and is called an optimum solution. Here, f(x*) can be a local minimum or a local maximum. A conventional processing method for performing nonlinear optimization to compute an optimum solution x* is known.

A processing system that performs nonlinear optimization for a function f(x), using such a method, adopts an iterative method. The iterative method is a method by which xₖ is changed step by step from its initial value x₀ until a target optimum solution x* is obtained. At each step of the iterative method, a specific method is taken to determine a search direction vector d representing a certain direction, determine a scalar value a that makes a functional value f(xₖ+αd) at a point xₖ+αd given by changing x linearly along d the minimum or maximum on the line for the linear change, and determine xₖ+αd to be a starting point xₖ₊₁ for the next step. This method of determining a is referred to as line search.

A conventional processing system that performs nonlinear optimization needs to carry out calculations on the nonlinear function f(x) and its derivatives (gradients) several times for determining a at each step of the iterative method. When practical problems in the above systems are solved, such calculations require an enormous processing time. For this reason, a means for reducing an amount of calculations at each step of the iterative method, thus reducing a time required for the whole processing, has been expected for years.

Japanese Patent No. 3845029 describes a technique related to a nonlinear optimum solution search apparatus that uses a computer having a processing program functioning as a bracketing means that by selectively using multiple increasing/decreasing coefficients, determines a section including the minimum (or the maximum) of a function f while changing a step size α and as a minimum search means (maximum search means) that carries out calculation of the minimum in the section (or the maximum), reduces iterative processes executed during line search and effectively searches for a nonlinear optimum solution.

This technique has led to a processing system that performs nonlinear optimization at a processing speed faster than that of a processing system that performs nonlinear optimization using a conventional bracketing means and optimum solution search means.

Patent Document 1: Japanese Patent No. 3845029.

### SUMMARY

A calculation time required by a processing system that performs nonlinear optimization will be described in a formulated manner. To solve a nonlinear optimization problem, usually a gradient method is used. A gradient is the first order derivative of a multidimensional function f(x), which represents the steepest slope at a point x. The gradient method starts at an arbitrary point x₀ and takes iterative steps to reach an optimum solution x* that makes f(x*) a (local) minimum (or maximum). A well-known example of the gradient method is the conjugate gradient method. A calculation time T required by a processing system that performs nonlinear optimization using the conjugate gradient method will be formulated using an expression (1), where Φ₁ denotes a constant representing a calculation time for calculations other than iterated sections, N denotes the number of iterations, mₖ denotes the number of times of calculations on a function f and its derivatives (hereinafter “calculation amount”) necessary for line search at one iterative step (hereinafter “search step”), τ denotes a time required for the calculations on the function f and its derivatives, and Φ₂ denotes a time required for other calculations during line search. In dealing with a large-scale optimization problem, τ becomes extremely large, compared to Φ₂ and Φ₁. To reduce T, therefore, N and mₖ should be taken into consideration.

$$\begin{matrix}[ Exp . 1 ] & \\ T = {φ}_{1} + {\sum }_{k}^{N} ( {m}_{k} τ + {φ}_{2} ) & ( 1 )\end{matrix}$$

In a case where all search direction vectors dₖ are assumed to be conjugate to a positive definite Hessian matrix of the function f, the number of iterations N becomes equal to the number of dimensions n of x, according to the theoretical principle of the conjugate gradient method. In general, however, the search direction vectors dₖ are not exactly conjugate, and sufficiently minimizing f requires execution of n or more iterative steps. For this reason, the iterative steps are usually ended based on certain convergence conditions. If an exact step size αₖ is calculated at each search step, an exact search direction vector dₖ₊₁ is calculated at the next search step k+1. This means that calculating the exact step size αₖ leads to a reduction in the number of iterations N.

However, an excessive demand for the exactness of the step size α leads to a need of an increase in the calculation amount mₖ at each search step, in which case the calculation time T for the processing increases. It is therefore concluded that in the case of a large-scale nonlinear optimization problem in which T becomes extremely large, trying to reduce the calculation time T by pursuing the exact step size αₖ is not a realistic approach.

Japanese Patent No. 3845029 describes a processing method for nonlinear optimization problems which method improves bracketing minimum (maximum) efficiency, thereby reducing mₖ to increase a processing speed, compared to a conventional processing method for nonlinear optimization problems using the bracketing method. The technique described in Japanese Patent No. 3845029 achieves more efficient bracketing but still requires multiple times of calculations on the function and its derivatives at each search step. To increase the processing speed, therefore, mₖ must be further reduced.

For the above reasons, shortening the calculation time T for the processing not by reducing the number of iterations N but by reducing mₖ at each search step to the minimum has been considered. One method of increasing the processing speed by reducing mₖ is known as a processing method for nonlinear optimization problems using a gradient method involving line search based on parabolic approximation (hereinafter “conventional processing method for nonlinear optimization problems).

The conventional processing method for nonlinear optimization problems is a method that regards functional values on a searched line as a quadratic function with respect to a step size and determines a step size up to a critical point at which a functional value becomes the minimum or maximum to be a, based on functional values and derivatives at multiple points on the line. This processing method allows a to be determined with less calculation amount mₖ and is therefore provided as a processing method for nonlinear optimization problems that significantly reduces the calculation amount mₖ at each search step to increase the processing speed.

However, the conventional processing method for nonlinear optimization problems as described above still needs multiple times of calculations on the function and its derivatives at each search step, which is the main factor for increasing the calculation time T for the processing. Hence a processing system that further reduces mₖ to perform nonlinear optimization with a higher processing speed has been expected for long time.

A nonlinear optimization method is described herein that increases the speed of calculating a nonlinear optimum solution by making a calculation process at each search step efficient. A processing system that performs nonlinear optimization and a non-transitory computer readable medium recording a processing program thereon are also described.

The techniques described herein can be carried out in various forms, such as methods, systems, devices, and apparatuses (including graphical user interfaces and computer-readable media).

In order to solve the above problems, a processing system that performs nonlinear optimization is described. The processing system comprises a memory unit storing therein a processing program for causing a computer to function as a search means that, based on a line search method for calculating a step size α at each search step through parabolic approximation, repeats a process of proceeding from a reference point, which is a known current critical point, in the direction of a search direction vector by the step size α for determining an unknown critical point at the search step, thereby determines a minimum or maximum of a function f, and a processing unit that searches for a nonlinear optimum solution to the function f, using the processing program. The search means includes an initial information obtaining means that stores an arbitrary reference point x₀ as an initial value, in the memory unit, and a critical point approximating means that at a search step at which a critical point is searched for from a certain reference point, approximates a step size α up to the critical point, using a first-order derivative f′ (x) at the reference point and the search direction vector d, the critical point approximating means also approximating a first-order derivative f′ (x+αd) at the critical point and storing the approximated step size α and first-order derivative f′ (x+αd) in the memory unit. The critical point is determined to be the next reference point and the first-order derivative f′ (x+αd) of the function approximated by the critical point approximating means is determined to be a first-order derivative of the function at the next reference point to carry out nonlinear optimization at the next reference point.

In this configuration, a favorable approximation of the derivative f′ (x+αd) at the critical point can be obtained by only one differential calculation at each search step. As a result, when a large-scale nonlinear optimization problem requiring a large amount of calculations is processed, mₖ at each search step is reduced and consequently the calculation time T is reduced significantly, compared to the conventional case.

According to one embodiment, the search means includes a temporary critical point memory means that at a search step at which a critical point is searched for from a certain reference point, determines a first-order derivative f′ (x+σd) at a temporary critical point reached by proceeding from the reference point in the direction of the search direction vector d by a temporary step size σ, which is a minute none-zero scalar value, and that stores the first-order derivative f′ (x+σd) in the memory unit. The critical point approximating means approximates the first-order derivative f′ (x+αd) at the critical point, using the first-order derivative f′ (x) at the reference point, the first-order derivative f′ (x+σd) at the temporary critical point, the temporary step size σ, and the step size α.

According to an embodiment, the step size α is determined by calculation using a second-order derivative approximated by a finite difference approximation method, with respect to a quadratic function of α, given by a functional value f(x+αd) approximated to a parabola by proceeding in a direction of the search direction vector d by α.

According to an embodiment, the critical point approximating means approximates the functional value f(x+αd) at the critical point, using the second-order derivative.

According to an embodiment, the initial information obtaining means stores a convergence criterion co for convergence test in the memory unit, and the search means includes a judging means that judges whether convergence occurs or not using the convergence criterion co and the first-order derivative f′ (x+αd) at the critical point. When the judging means judges that convergence does not occur, the temporary critical point memory means and the critical point approximating means determine a calculated critical point to be a new reference point and carry out a process for next search step at which an unknown critical point is searched for.

According to an embodiment, at each search step, the search means judges whether or not to adopt one or more approximations calculated by the critical point approximating means. When not adopting the approximation at the search step, the search means replaces a value calculated as the approximation with a directly calculated value determined by direct calculation.

In this configuration, compared to a case where all approximations are adopted for calculating an optimum solution, more stable processing is achieved.

According to an embodiment, the search means judges validity of convergence, using one or more of values calculated at each search step.

When a preset condition is not met, the search means traces back search steps by one or more steps to reach a preceding search step, at which the search means replaces an approximation calculated by the critical point approximating means with a directly calculated value determined by direct calculation.

According to an embodiment, the search means uses a gradient method.

This configuration provides a processing system that performs nonlinear optimization of searching for a minimum or maximum of the function f using the gradient method.

According to an embodiment, the search means stores at least calculated values calculated at a series of preceding search steps one step before the current search step, the first-order derivative f′ (x+σd), and the first-order derivative f′ (x+αd), in the memory unit.

This configuration provides a processing system that performs nonlinear optimization allowing fast iterative processing.

The described embodiments provide a machine learning method according to which a learning process is executed based on training data, using the processing system that performs nonlinear optimization.

In this configuration, in a machine learning process of learning functional approximation, classification, etc., by carrying out calculations on a large volume of training data at each search step and searching for an optimum solution, the number of times of calculations at each search step can be reduced to the minimum. As a result, a machine learning method that significantly increases a learning speed is provided.

The described embodiments also provide a learning method for an artificial neural network according to which method a learning process is executed through error function minimization based on training data, using the processing system that performs nonlinear optimization.

In this configuration, in a learning process by an artificial neural network that requires calculation on a large volume of training data and search for an optimum solution, the number of times of calculations at each search step is reduced to the minimum. As a result, an artificial neural network with a significantly increased learning speed is constructed.

The described embodiments also provide a non-transitory computer readable medium recording thereon a processing program for causing a computer to function as a search means that based on a line search method for calculating a step size α at each search step through parabolic approximation, repeats a process of proceeding from a reference point, which is a known current critical point, in the direction of a search direction vector d by the step size α for determining an unknown critical point at the search step, thereby determines a minimum or maximum of a function f. The search means includes an initial information obtaining means that stores an arbitrary reference point x₀ as an initial value, in the memory unit, and a critical point approximating means that at a search step at which a critical point is searched for from a certain reference point, approximates the step size α up to the critical point, using a first-order derivative f′ (x) at the reference point and the search direction vector d, the critical point approximating means also approximating a first-order derivative f′ (x+αd) at the critical point and storing the approximated step size α and first-order derivative f′ (x+αd) in the memory unit. The search means determines the critical point to be the next reference point and determines the first-order derivative f′ (x+αd) of the function approximated by the critical point approximating means to be a first-order derivative of the function at the next reference point to carry out nonlinear optimization at the next reference point.

As used herein, the critical point approximating means, the temporary critical point memory means, the judging means, the initial information obtaining means, and the search means can be realized by hardware, such as a processing unit, processing software, and combinations thereof.

The described embodiments also provide a nonlinear optimization method according to which, based on a line search method for calculating a step size α at each search step through parabolic approximation, a process of proceeding from a reference point, which is a known current critical point, in the direction of a search direction vector by the step size α for determining an unknown critical point at the search step is repeated to determine a minimum or maximum of a function f. According to the method, an arbitrary reference point x₀ is stored as an initial value in the memory unit, and at a search step at which a critical point is searched for from a certain reference point, the step size α up to the critical point is approximated using a first-order derivative f′ (x) at the reference point and the search direction vector d, a first-order derivative f′ (x+αd) at the critical point is also approximated, and the approximated step size α and first-order derivative f′ (x+αd) are stored in the memory unit. The critical point is determined to be the next reference point, and determining the approximated first-order derivative f′ (x+αd) to be a first-order derivative of the function at the next reference point.

The described embodiments also provide a machine learning system that executes a learning process based on training data, using the nonlinear optimization method.

The described embodiments also provide an artificial neural network system that carries out error function minimization based on training data, thereby executing a learning process, using the nonlinear optimization method.

One embodiment provides a nonlinear optimization method that improves the speed of calculating a nonlinear optimum solution by increasing the efficiency of a calculation process at each search step to the maximum, a processing system that performs nonlinear optimization, and a non-transitory computer readable medium storing a processing program thereon.

### BRIEF DESCRIPTIONS OF THE DRAWINGS

FIG. 1 depicts an example of a nonlinear optimization problem;

FIG. 2 shows steps plotted on a two dimensional plain of x in FIG. 1;

FIG. 3 is a conventional process flowchart for solving a nonlinear optimization problem;

FIG. 4 is a process flowchart for a nonlinear optimization method according to a first embodiment described herein;

FIG. 5 depicts a hardware configuration of a processing system that performs nonlinear optimization according to the first embodiment;

FIG. 6 depicts a hardware configuration of a processing system that performs nonlinear optimization according to a second embodiment; and

FIG. 7 depicts a hardware configuration of a processing system that performs nonlinear optimization according to a third embodiment described herein.

### DETAILED DESCRIPTION

### First Embodiment

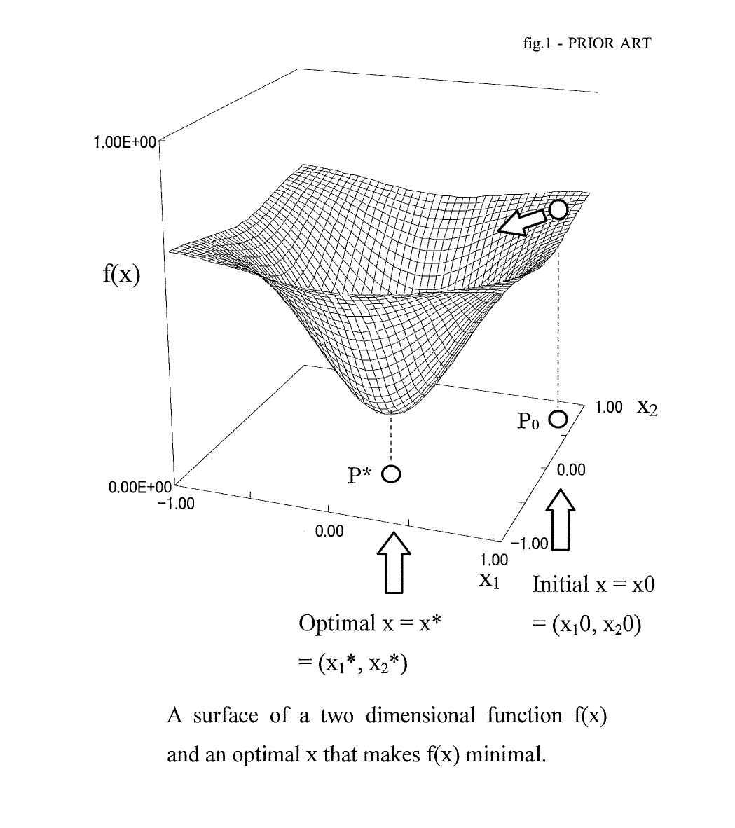

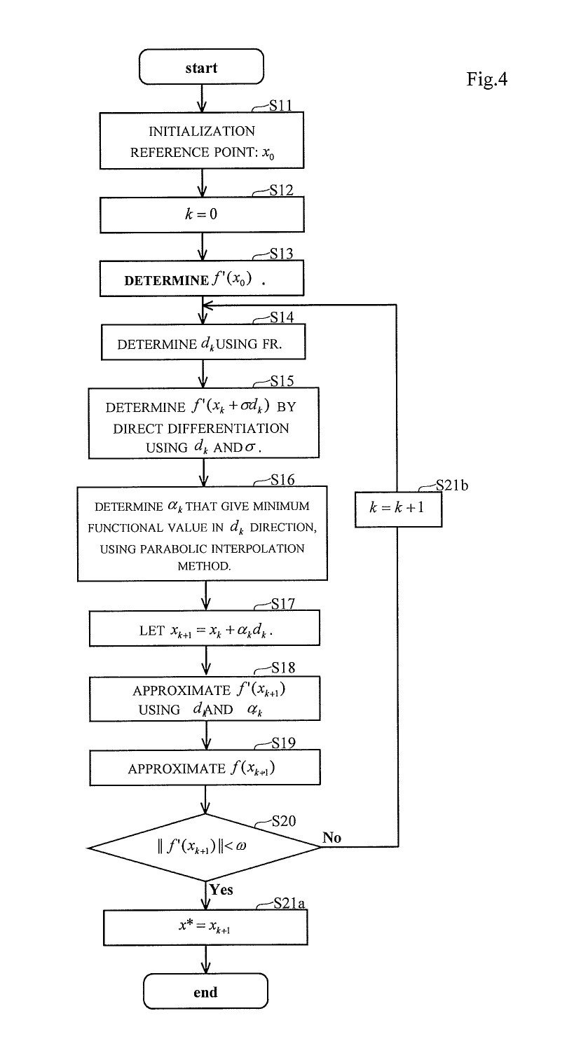

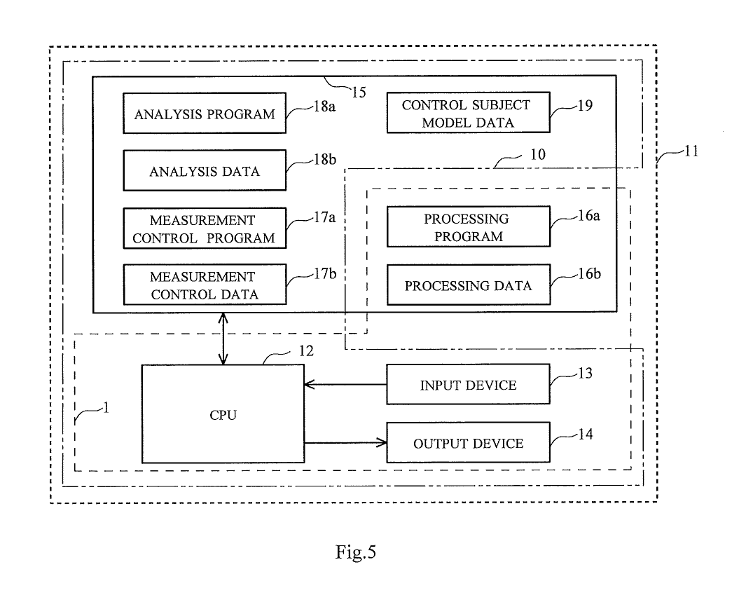

A first embodiment will hereinafter be described, referring to FIGS. 4 to 5 along with FIG. 1 to FIG. 3 which illustrates a conventional process. Configurations described in the following embodiment are examples, and the claimed invention is not limited to those configurations of the described embodiments. The outline of the first embodiment will be described, using a conjugate gradient method. The first embodiment applies also to nonlinear optimization problem solution algorithms other than the conjugate gradient method, and a processing system that performs nonlinear optimization according to the first embodiment using such nonlinear optimization problem solution algorithms may also be configured.

### (1) Explanation of Conjugate Gradient Method

The conjugate gradient method will first be explained. Minimization of f(x) will be explained in the following description, in which the same method applied to minimization of f(x) can also be applied to maximization of f(x). This embodiment will be described using the conjugate gradient method as a nonlinear optimization problem solution algorithm.

An optimum solution x* to an unconstrained nonlinear optimization problem in application of the conjugate gradient method is calculated in general by applying an iterative method represented by an expression (3) to an expression (2). An expression (4) gives a search direction vector d by using the conjugate gradient method. In a nonlinear optimization problem, the objective function f is usually a multivariable function. xₖ and dₖ, therefore, each denotes a multidimensional vector in the k-th iteration. For example, if xₖ is an n dimensional vector, xₖ=(v₁, v₂, v₃, . . . vₙ)ₖ consists of values vᵢ(1≦i≦n). In the expression (4), gₖ represents the gradient of the function f; i.e. gₖ=∇f(xₖ)=(∂f/∂v₁, ∂f/∂v₂, ∂f/∂v₃, . . . , ∂f/∂vₙ)ₖ. Differential defined in this disclosure thus includes not only differential in a one-dimensional domain but also differential in a multidimensional domain, i.e. gradient calculation. For example, f′ (xₖ) represents ∇f(xₖ). A step size αₖ is a scalar value.

$$\begin{matrix}[ Exp . 2 ] & \\ min f ( x ) , x ∈ {R}^{n} & ( 2 ) \\ [ Exp . 3 ] & \\ {x}_{k + 1} = {x}_{k} + {a}_{k} {d}_{k} & ( 3 ) \\ [ Exp . 4 ] & \\ {d}_{k} = \{ \begin{matrix}- {g}_{k} & for k = 0 \\ - {g}_{k} + {β}_{k} {d}_{k - 1} & for k > 0\end{matrix} & ( 4 )\end{matrix}$$

According to the gradient method, each of repeated process steps is defined as a search step and a point used as a point of reference to search at each search step is defined as a reference point. The optimum solution x* is calculated while a critical point that gives the minimum (maximum in the case of a maximization problem) of a one-dimensional quadratic function including the reference point is searched for at each search step. An initial reference point is given arbitrarily as x₀, and x₁ that is searched for based on the reference point x₀ is determined to be an initial critical point. Critical points include a critical point determined approximately as a strictly-defined critical point on the one-dimensional quadratic function.

A critical point xₖ₊₁ calculated at each search step k by the gradient method is subjected to convergence test using a derivative f′ (xₖ₊₁) of the function f at the critical point and a convergence criterion co. When the critical point xₖ₊₁ is judged to be a convergence point by the convergence test, the critical point xₖ₊₁ is determined to be the optimum solution x*. When the critical point xₖ₊₁ is judged to be a non-convergence point, the calculated critical point xₖ₊₁ is determined to be a new reference point, based on which a search step k+1 for finding an unknown critical point xₖ₊₂ is started. The convergence test may be carried out by any given method. For example, the convergence test may be carried out using not a derivative but a functional value.

The search direction vector d of the expression (4) given by the conjugate gradient method is calculated by several methods, such as Fletcher-Reeves (FR), Hestenes-Stiefel (HS), Polak-Ribiere (PR), and Dai-Yuan (DY). In this embodiment, FR indicated by an expression (5) is used as a specific example of those calculation methods.

$$\begin{matrix}[ Exp . 5 ] & \\ {β}_{k}^{F - R} = \frac{{g}_{k}^{T} {g}_{k}}{{g}_{k - 1}^{T} {g}_{k - 1}} & ( 5 )\end{matrix}$$

### (2) Conventional Line Search Based on Parabolic Approximation

Conventional line search based on parabolic approximation will now be described. In this embodiment, a parabolic interpolation method is used as a parabolic approximation algorithm. If an exact step size αₖ is given at each search step, exact dₖ₊₁ that, in theory, sets an ideal search direction is given, in which case early convergence results (reduction in the number of iterations N). Enhancing the precision of the line search in dealing with an actual large-scale optimization problem, however, leads to repeated calculations of too many functions and gradients, thus resulting in an increase in a calculation time T, which is not a realistic approach (increase in mₖ). For this reason, a method for efficiently determining the step size αₖ is applied in general.

A functional value f(x+αd) at a point x+αd can be approximated by Taylor expansion, as indicated by an expression (6). f′ (x)=∇f(x) represents the gradient of the function f, and f″ (x) represents a Hessian matrix.

$$\begin{matrix}[ Exp . 6 ] & \\ f ( x + α d ) \approx f ( x ) + {α [ {f}^{′} ( x ) ]}^{T} d + \frac{{α}^{2}}{2} {d}^{T} {f}^{″} ( x ) d & ( 6 )\end{matrix}$$

The right-hand member of the expression (6) expresses a parabola, that is, one-dimensional quadratic function with an independent variable a. From this approximate expression (6), subjecting f(x+αd) to first-order differential and second-order differential with respect to a yields expressions (7) and (8). To determine a critical point, the left-hand member of the equation (7) is set equal to zero and is solved with respect to α. This gives an expression (9), in which α* denotes a step size up to the critical point on the quadratic function.

$$\begin{matrix}[ Exp . 7 ] & \\ \frac{d}{d α} f ( x + α d ) \approx {[ {f}^{′} ( x ) ]}^{T} d + α {d}^{T} {f}^{″} ( x ) d & ( 7 ) \\ [ Exp . 8 ] & \\ \frac{{d}^{2}}{d {α}^{2}} f ( x + α d ) \approx {d}^{T} {f}^{″} ( x ) d & ( 8 ) \\ [ Exp . 9 ] & \\ {α}_{*} \approx - \frac{{[ {f}^{′} ( x ) ]}^{T} d}{{d}^{T} {f}^{″} ( x ) d} & ( 9 )\end{matrix}$$

f″ (x) included in the denominator of the expression (9) is hard to calculate directly and takes an extremely long time for calculation. To avoid such a situation, an arbitrary minute non-zero value is determined to be a temporary step size σ, and a first-order derivative of the function f is calculated at a reference point x and a temporary critical point x+σd, which are different two points on the function f. In this manner, d^{T}f″(x)d is approximated by a finite difference approximation method (expression (10)). The expression (10) is then substituted in the expression (9) to approximate α* (expression (11)). Although d^{T}f″ (x) d is approximated by the finite difference approximation method in the expression (10), an approximation of d^{T}f″ (x)d may also be determined by another method.

When f represents a quadratic function, f(x+αd) represents an exact parabolic function of α, and the step size α* determined by the expression (9) takes a value exactly indicating the critical point. When the finite difference approximation method is used, the line search using the parabolic interpolation method satisfies in many cases strong Wolfe conditions at one calculation of a. As a result, at one calculation for determining the step size αₖ, an optimum step size αₖ* at each search step is calculated with preferable precision.

$$\begin{matrix}[ Exp . 10 ] & \\ \begin{matrix}{d}^{T} {f}^{″} ( x ) d \approx \frac{\frac{d}{d σ} f ( x + σ d ) - {[ {f}^{′} ( x ) ]}^{T} d}{σ} \\ = \frac{{[ {f}^{′} ( x + σ d ) ]}^{T} d - {[ {f}^{′} ( x ) ]}^{T} d}{σ}\end{matrix} & ( 10 ) \\ [ Exp . 11 ] & \\ {α}_{*} \approx - \frac{{σ [ {f}^{′} ( x ) ]}^{T} d}{{[ {f}^{′} ( x + σ d ) ]}^{T} d - {[ {f}^{′} ( x ) ]}^{T} d} & ( 11 )\end{matrix}$$

### (3) Explanation of Conventional Processing Method for Nonlinear Optimization Problems

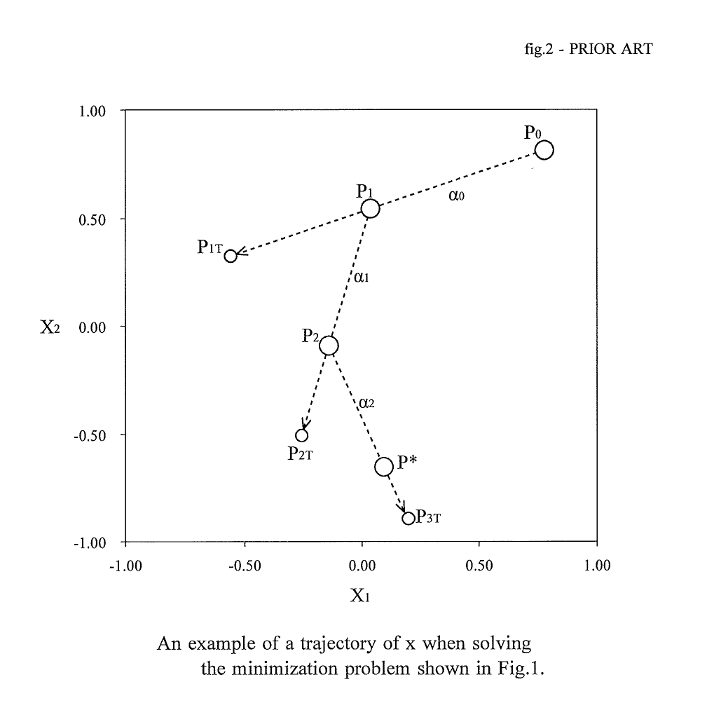

A conventional processing method for nonlinear optimization problems will now be described, referring to FIG. 1 to FIG. 3. FIG. 1 depicts an example of the nonlinear optimization. The surface represents a function f with respect to a two dimensional variable x. FIG. 2 shows the steps plotted on the two dimensional plain of x in FIG. 1. The dimension can be thousands or more. A point P₀ represents the starting point and P* represents the optimum solution where f(x) is the minimum. The gradient method changes the value of x step by step to reach P* from P₀. The final output is the combination of values, x₁* and x₂*. The gradient and the function value at P₀ are known by the initialization step. The iterative steps of the prior art is as follows. First, P_{1T} is reached by the temporary step size σ to compute the gradient at the point. Using the gradient at two points, P₀ and P_{1T}, a step size α₀ that makes P₁ a critical point, which is a minimum point along the line between P₀ and P_{1T} is computed. Then, P₁ is turned into the starting point for the next step and the gradient at P₁ is computed directly. As above this procedure is repeated to find P₂ and P* is reached. Although P* is reached in 3 steps, the number of steps required in practical applications can be thousands or more. Gradients have to be computed twice in each step, hence, 6 times as total in this example of a conventional method.

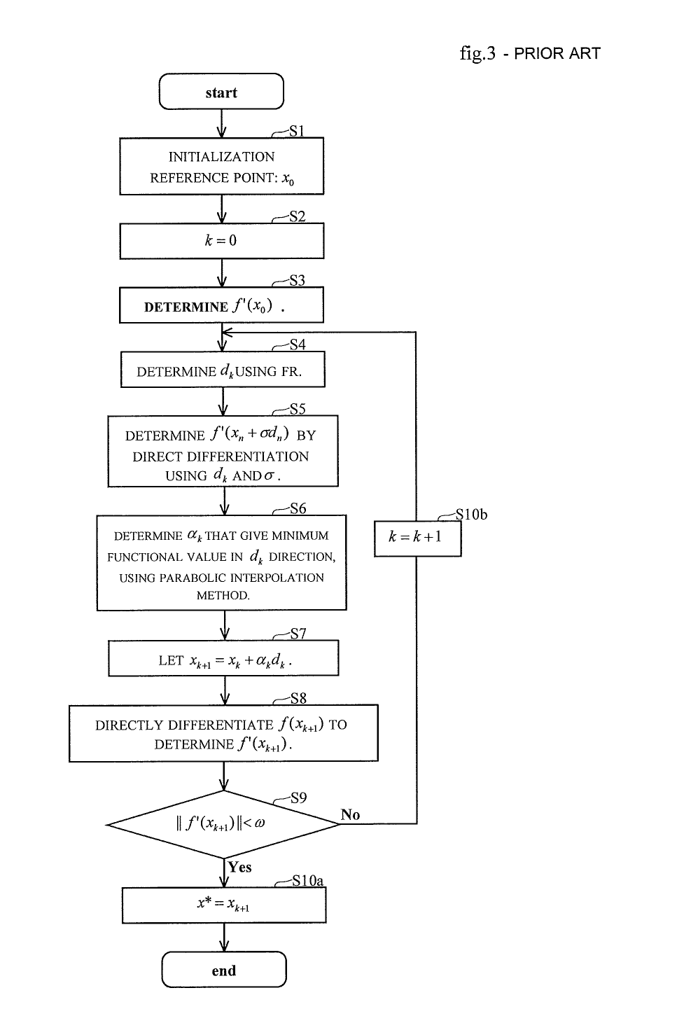

FIG. 3 is a flowchart of the conventional process for solving a nonlinear optimization problem. At step 1 (S1), initialization according to the gradient method is carried out. A reference point x₀ for k=0 as well as a convergence criterion ω and an arbitrary minute value σ, which are treated as initial information, are input, after which a search step for k=0 (calculation of a critical point xₖ₊₁ and assessment of the calculation) is started (step 2 (S2)). At S3, f(x₀) is differentiated to calculate f f (x₀). The calculated ff(x₀) is then applied to FR to determine a search direction vector d₀ (S4).

At S5, f′ (xₖ+σdₖ) is determined by direct differential calculation, using a search direction vector dₖ determined at S4. “direct differential calculation” means not only analytic differentiation but also automatic, symbolic, and numerical differentiation, and backpropagation. When f′ (xₖ+σdₖ) is determined, the value of a step size αₖ up to an unknown critical point is approximated, based on the parabolic interpolation method and finite difference approximation method (S6). A temporary step size σₖ may be determined by calculating its preferred value at each search step.

Since αₖ and dₖ have been determined by the above steps, the unknown critical point is determined to be xₖ₊₁=xₖ-αₖdₖ (S7). A functional value f (xₖ₊₁) at xₖ₊₁ is then calculated by direct functional calculation. By directly differentiating f (xₖ₊₁), the gradient f′ (xₖ₊₁) of the function f at xₖ₊₁ is calculated (S8).

At S9, whether the gradient f′ (xₖ₊₁) of the function f at the critical point xₖ₊₁ calculated at S8, has converged or not is judged, using the convergence criterion co. When it is judged that the gradient f′ (xₖ₊₁) has converged (Yes at S9), xₖ₊₁ is determined to be the optimum solution x* to the function f (S10a). When it is judged that the gradient f′ (xₖ₊₁) has not converged (No at S9), the value of k is increased by 1 at S10b and the process flow returns to S4, at which the next search step is started to calculate an unknown critical point xₖ₊₂ with reference to the above calculated critical point xₖ₊₁ determined to be a reference point. Thus, convergence assessment at S9 is continued as search steps are repeated until the convergence test determines convergence of the gradient f′ (xₖ₊₁). The convergence test at S9 may be carried out using a value other than the gradient of f, such as a or d.

### (4) Explanation of Processing Method for Nonlinear Optimization Problems According to the First Embodiment

Approximate line search and a processing method for nonlinear optimization problems according to the first embodiment will now be described, referring to FIG. 4. The same constituent elements as included in the above conventional processing method for nonlinear optimization problems will be omitted in further description. Steps S11 to S17 are the same as steps S1 to S7 of the conventional processing method depicted in the flowchart of FIG. 3.

According to the conventional processing method for nonlinear optimization problems depicted in FIG. 3, because of use of the finite difference approximation method indicated by the expression (10), direct differential calculation of xₖ+σdₖ (S5) and of xₖ₊₁ (S8) is necessary. This means that direct differential calculation on two points must be carried out at one search step.

The length of a calculation time T required for solving a nonlinear optimization problem depends on the number of iterations N and on the number of times mₖ of differential calculations and functional calculations carried out at each search step. Now, line search according to the first embodiment is applied at S18. This offers a processing method for nonlinear optimization problems that reduces the number of times of direct differential calculations at each search step, thereby reduces the calculation time T for the whole processing. In the first embodiment, exact gradients at P₁, P₂, and P* are not computed; instead, these gradients are approximated from known values at each step. Therefore, the exact gradients are directly computed only for P_{1T}, P_{2T}, and P_{3T}, and the number of gradient computation is reduced from 6 to 3 in the example described in FIG. 1 and FIG. 2. Because the computing exact gradient takes tremendous time for some applications, the reduction of computation time is large. The iteration may accumulate errors for the approximation, and the errors affect the path and number of steps to reach the solution. However, experiments indicated that the overall computation time of a program using the processing method for nonlinear optimization problems according to the first embodiment was near 50% of the conventional one.

In an assumed case where a Hessian matrix H is given, f′ (x+αd) can be transformed into the right-hand member of an expression (12), where ε denotes an error term, which will be omitted in the following description on the assumption that f can be approximated sufficiently into a quadratic expression. By replacing a in the expression (12) with σ, Hd is expressed in the form of an approximate expression (13).

$$\begin{matrix}[ Exp . 12 ] & \\ {f}^{′} ( x + α d ) = {f}^{′} ( x ) + α H d + ɛ & ( 12 ) \\ [ Exp . 13 ] & \\ H d \approx \frac{{f}^{′} ( x + σ d ) - {f}^{′} ( x )}{σ} & ( 13 )\end{matrix}$$

Hd approximated by expression (13) is substituted in the expression (12) and a is replaced with α*, which yields an expression (14). Hence the value of f′ (x+αd), which is determined by gradient calculation in the conventional case, is given by approximation. In the expression (14), f′ (x) has already been calculated at the search step one step before the current search step and f′ (x+σd) has been calculated at S15. Therefore, f′ (x+αd), which represents differential calculation at a critical point at each search step, can be calculated recursively, using already calculated values. f′ (x+αd) with a subscript k denoting the number of search steps is expressed in an expression (15), and α with a subscript k denoting the number of search steps is expressed in an expression (16).

$$\begin{matrix}[ Exp . 14 ] & \\ {f}^{′} ( x + {α}_{*} d ) \approx \frac{{α}_{*}}{σ} [ {f}^{′} ( x + σ d ) - {f}^{′} ( x ) ] + {f}^{′} ( x ) & ( 14 ) \\ [ Exp . 15 ] & \\ \begin{matrix}{f}^{′} ( {x}_{k + 1} ) = {f}^{′} ( {x}_{k} + {α}_{k} {d}_{k} ) \\ = \frac{{α}_{k}}{σ} [ {f}^{′} ( {x}_{k} + σ {d}_{k} ) - {f}^{′} ( {x}_{k} ) ] + {f}^{′} ( {x}_{k} )\end{matrix} & ( 15 ) \\ [ Exp . 16 ] & \\ {α}_{k} = - \frac{{σ [ {f}^{′} ( {x}_{k} ) ]}^{T} {d}_{k}}{{[ {f}^{′} ( {x}_{k} + σ {d}_{k} ) ]}^{T} {d}_{k} - {[ {f}^{′} ( {x}_{k} ) ]}^{T} {d}_{k}} & ( 16 )\end{matrix}$$

As described above, because f′ (x) has been calculated at the search step one step before the current search step and f′ (x+σd) has been calculated when the step size α is determined using the finite difference approximation method, f′ (x+αd) can be calculated very easily by a simple substitution procedure. This reduces the number of times of direct differential calculations at one search step to one, that is, one direct differential calculation of f′ (x+σd). In the case of processing a large-scale nonlinear optimization problem, therefore, the calculation time T required for the processing is reduced significantly. Specifically, the number of times of differential calculations, which is at least two times or more at each search step in the conventional case, is reduced to one. However, determining the first-order derivative f′ (x₀) at the search step for k=0 still requires direct differential calculation.

When f′ (xₖ₊₁) is approximated at S18, whether f′ (xₖ₊₁) converges or not is judged in the same manner as in the conventional case (S20). When it is judged that f′ (xₖ₊₁) has converged (Yes at S20), the critical point Xₖ₊₁ is determined to be the optimum solution x* to f (S21a). When it is judged that f′ (xₖ₊₁) has not converged (No at S20), the value of k is increased by 1 (S21b) and the process flow returns to S14, at which the next search step is started to calculate an unknown critical point xₖ₊₂ with reference to the above calculated critical point xₖ₊₁ determined to be a reference point. The convergence test at S20 may be carried out using a value other than the gradient of f, such as a functional value for f(xₖ₊₁), a, or d.

When necessary, a functional value for f(xₖ₊₁) may also be approximated during a series of steps of S18 to S20 (S19). As described above, the convergence test may be carried out using such an approximated functional value for f (xₖ₊₁). This makes direct functional calculation on f(xₖ₊₁) unnecessary, thus further reducing a time required for calculation at one search step. To determine a functional value for f(xₖ₊₁) (=f (xₖ+αₖdₖ)) by approximation, an expression (17) is used, which is given by replacing x and a in the expression (6) with x+σd and α−σ, respectively.

$$\begin{matrix} [ Exp . 17 ] & \\ f ( x + α d ) \approx f ( x + σ d ) + {( α - σ ) [ {f}^{′} ( x + σ d ) ]}^{T} d + \frac{{( α - σ )}^{2}}{2} {d}^{T} {f}^{″} ( x + σ d ) d ( ∵ f ( x + α d ) = f ( x + σ d + α d - σ d ) ) & ( 17 )\end{matrix}$$

To approximate d^{T}f″ (x+αd) d in the expression (17), a minute non-zero value μ is given to the expression (17), which yields an expression (18). Now setting μ=−σ gives an expression (19).

$$\begin{matrix}[ Exp . 18 ] & \\ {d}^{T} {f}^{″} ( x + σ d ) d \approx \frac{{[ {f}^{′} ( x + σ d + μ d ) ]}^{T} d - {[ {f}^{′} ( x + σ d ) ]}^{T} d}{μ} & ( 18 ) \\ [ Exp . 19 ] & \\ Let μ = - σ , then \\ {d}^{T} {f}^{″} ( x + σ d ) d \approx \frac{{[ {f}^{′} ( x + σ d ) ]}^{T} d - {[ {f}^{′} ( x ) ]}^{T} d}{σ} & ( 19 )\end{matrix}$$

Substituting the expression (19) in the expression (17) then results in an approximation of f(xₖ₊₁). The right-hand member of the expression (19) is identical with the right-hand member of the expression (10) for approximating a. This means that a value for f(xₖ₊₁) is not determined by direct functional calculation but by approximation using only the value already determined in the stage of calculating αₖ. The amount of calculation is therefore reduced.

Obviously, determining f(x+αd) by direct functional calculation is by no means problematic, but such an approach increases the amount of calculation at each search step, thus increasing the calculation time T required for determining the optimum solution x*. Depending on the configuration of a processing program to apply, f (xₖ+σdₖ) is calculated for determining f′ (xₖ+σdₖ), in which case the number of times of calculations for approximating f(xₖ+αₖdₖ) does not increase.

The flowchart of FIG. 4 shows the case of applying the processing method for nonlinear optimization problems in which case search steps are repeated. Under an arbitrary condition, however, a different process may be introduced.

For example, whether or not to adopt a calculated approximate value, such as the step size α, f′(xₖ-αₖdₖ) and f(xₖ+αₖdₖ), may be judged based on a preset condition and a process not included in the flowchart of FIG. 4 may be carried out according to the resulting judgment. When it is judged at a certain search step that such an approximate value is not adopted, for example, the approximate value may be replaced with a directly calculated value determined by direct calculation or a value determined by a different calculation method.

In another case, the validity of convergence may be judged using one or more of values obtained by the processing method for nonlinear optimization problems and the approximate value adoption judgment, and a process not included in the flowchart of FIG. 4 may be carried out according to the resulting judgment. In one embodiment, under a condition of 0<α or 0<f(xₖ₊₁)<f(xₖ), a case of a parabola used by the parabolic interpolation method being convex in the functional minimum search, a case of f(xₖ₊₁) not converging, etc., can be identified and different processes be applied to such cases. Different processes include, for example, replacing the value of a calculated by approximation with a value calculated by a different method and replacing the value of f′ (xₖ₊₁) or f(xₖ₊₁) calculated by approximation with a directly calculated value determined by direct calculation in the same manner as in the case of the conventional processing method for nonlinear optimization problems. The value of the search direction vector d may be replaced with the gradient vector to restart the search process as a case of k=0 that is defined in the expression (4).

For reasons that will be described later, such value replacement process can be performed after execution of a tracing back process of tracing back to the search step one step or several steps before the current step and then steps of the flowchart of FIG. 4 be resumed. The result of the judgment on whether or not to adopt the above approximate value or a directly calculated value determined for replacing the approximate value may be used as criteria for tracing back, based on which criteria the tracing back process and value replacement process are carried out.

Even if these value replacement and tracing back processes are carried out, the frequency of appearance of these processes in an experiment of the calculation method for a nonlinear optimum solution accounts for 10% of the whole calculation process. Approximate values calculated by approximation are thus adopted for 90% of the whole calculation process, so that the amount of calculation as a whole is reduced significantly.

Compared to the case where the conventional calculation method for a nonlinear optimum solution is solely applied, therefore, the amount of calculation as a whole is reduced significantly, which allows fast calculation of the optimum solution. Applying the value replacement and tracing back processes realizes more stable optimum solution calculation.

(5) Example of Hardware Configuration of Processing System that Performs Nonlinear Optimization

A hardware configuration of a processing system 1 according to the first embodiment, the processing system 1 optimizing parameters for a control simulation system, thus performing nonlinear optimization, will be described, referring to FIG. 5. The processing system 1 that performs nonlinear optimization uses the above processing method for nonlinear optimization problems. A control simulation system 10 generates control information for a control simulation, using the parameters optimized and outputted by the processing system 1. FIG. 5 depicts a hardware configuration for the embodiment, where the processing system is included in the same computer as that of the control simulation system.

In this example, the processing system 1 that performs nonlinear optimization includes a computer 11 having a processing unit (CPU) 12, an input device 13, an output device 14, and a processing program 16a and processing data 16b that are stored in a memory 15. The control simulation system 10 includes the computer 11 having the processing unit 12, the input device 13, the output device 14, and the measurement control program 17a, measurement control data 17b, the analysis program 18a, analysis data 18b, and control subject model data 19 that are stored in the memory 15. In this embodiment, the measurement control program 17a, measurement control data 17b, the analysis program 18a, analysis data 18b, and control subject model data 19 can be stored in a memory that is separate from the memory 15 and accessible from the CPU 12. This embodiment shows an example that a processing program 16a is stored in memory 15 as software which is different from the application program (measurement control program 17a). But the disclosure is not limited to this embodiment. For example, an application program itself may be configured to include a processing program 16a as a sub-routine. As used herein, the language computer processing unit or CPU is intended to encompass a single-core CPU, a multi-core CPU, one or more graphical processing units (GPU), a computer cluster, any other computer hardware that executes instructions, and combinations thereof. The CPU 12 and the memory 15 may be connected to the input device 13, output device 14, etc., via a network in a distributive system arrangement. Examples of the input device 13 can include, but are not limited to, a keyboard, mouse, controller, touch screen (for example of the electromagnetic induction type, electrostatic capacity type, pressure-sensitive type, infrared type, surface acoustic wave type, matrix switch type, etc.), other devices via which data can be input, and combinations thereof. Examples of the output device 14 can include, but are not limited to, a visual display such as a display screen, a projector, other devices via which data can be displayed, and combinations thereof.

Control subject model data 19 represents a state of a control subject model, such as shape, replacement, velocity, temperature, flow, pressure, voltage, etc. The analysis program 18a analyzes and simulates the state of the control subject model data 19 according to a change in the control information.

According to the processing system 1 that performs nonlinear optimization, the objective function f(x), the initial control variable x₀, and the convergence criterion co that are subjected to the process indicated by the expression (2) are input to the processing system 1 through the input device 13, and are stored as the processing data 16b, in the memory 15. Subsequently, the processing program 16a stored in the memory 15 is executed. The processing program 16a calculates an optimum solution of the parameters that make the objective function the minimum or maximum, using an incoming measurement results from the measurement control program 17a and outputs the optimum solution to the measurement control program 17a. Measurement control program 17a receives the optimum solution from processing unit 12, generates control information based on the optimum solution, updates control over the control subject model data 19, based on the contents of the control information, and issues an analysis instruction to the analysis program 18a. The analysis program 18a then sends an analysis result back to the measurement control program 17a. By repeating the above process, optimum control parameters for the control subject model data 19 can be obtained.

According to the first embodiment, a processing program for optimizing control data for a control subject model is provided with a search means based on the processing method for nonlinear optimization problems. As a result, an optimum solution can be calculated as the number of times of differential calculations and functional calculations carried out at one search step is reduced to the minimum. This enables control simulation and numerical calculation faster than conventional control simulation and numerical calculation.

According to the line search method, the step size α can be calculated with precision bearing comparison with the precision of the conventional line search based on the parabolic interpolation method and the gradient at a critical point at each search step can be approximated. When a large-scale nonlinear optimization problem is processed, in particular, the calculation time T for the processing can be reduced significantly.

According to the processing method for nonlinear optimization problems, a functional value at a critical point at each search step can be approximated. As a result, the functional value at the critical point that must be calculated directly in the conventional case can be calculated recursively based on an already calculated value. Hence the calculation time T required for processing a nonlinear optimization problem can be reduced significantly.

### Second Embodiment

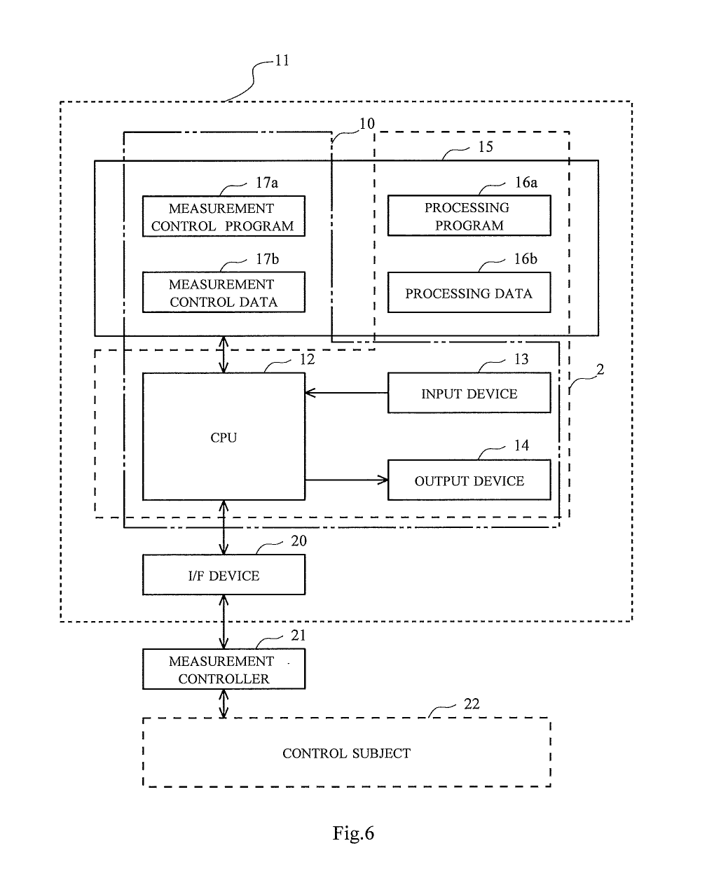

A hardware configuration of a processing system 2 that optimizes parameters for a control system, thus performing nonlinear optimization will be described, referring to FIG. 6. The processing system 2 that performs nonlinear optimization uses the above described processing method for nonlinear optimization problems. A control system 10 generates control information for an automatic control, using the parameters optimized and outputted by the processing system 2. FIG. 6 depicts a hardware configuration for the embodiment, where the processing system is included in the same computer as that of the control system. Constituent elements basically the same as constituent elements described in the first embodiment are denoted by the same reference numerals and are therefore omitted in further description.

The processing system 2 that performs nonlinear optimization includes the computer 11 having the CPU 12, the input device 13, the output device 14, the memory 15, and the processing program 16a and the processing data 16b that are stored in the memory 15. The control system 10 that use outputted value from the processing system 2 includes the computer 11 having the processing unit 12, the input device 13, the output device 14, and the measurement control program 17a and measurement control data 17b that are stored in the memory 15. The programs and data 16-19 reside in suitable memory. In this embodiment, the measurement control program 17a, measurement control data 17b, the analysis program 18a, analysis data 18b, and control subject model data 19 can be stored in a memory that is separate from the memory 15 and accessible from the CPU 12. The programs and data 16-19 reside in suitable memory. This embodiment shows an example that a processing program 16a is stored in memory 15 as software which is different from the application program (control program 17a) or a part of operating system. But the disclosure is not limited to this embodiment. For example, an application program itself may be configured to include a processing program 16a as a sub-routine. The CPU 12 is connected to an I/F device 20 that acquires measurement results from and transmits the control information to a measurement controller 21 that controls a control subject 22. The memory 15 has the processing program 16a stored therein, which executes the above search means based on the processing method for nonlinear optimization problems according to the first embodiment. The CPU 12 and the memory 15 may be connected to the input device 13, output device 14, etc., via a network in a distributive system arrangement.

According to the processing system 2 that performs nonlinear optimization, the objective function f(x), the initial control variable x₀, and the convergence criterion co are input to the processing system 2 through the input device 13, and are stored as the processing data 16b, in the memory 15. Subsequently, the processing program 16a stored in the memory 15 is executed. The processing program 16a calculates an optimum solution of the parameters that make the objective function the minimum or maximum, using an incoming measurement results from the I/F device 20, and outputs the optimum solution to the control system 10. The control system 10 receives the optimum solution from the processing unit 12, generates control information based on the optimum solution, and transmits the information to the I/F device 20. Receiving the control information via the I/F device 20, the measurement controller 21 updates control over the control subject 22, based on the contents of the control information, and carries out measurement again. By repeating the above process, optimum control over the control subject 22 is realized. The control subject 22 can be, but it not limited to, any device that is automatically controlled. In one example, the control subject 22 can be a pump device, gas-injecting device or a chemical-injecting device in a plant, or a robot on a production line in a factory. In another example, the control subject 22 can be an automobile, airplane or ship that can operate on automatic operation. Many other examples of control subjects 22 are possible.

For example, control system 10 can be a chemical injection control system for a water treatment plant. Usually, drinking water produced in a plant is transmitted to a storage tank located in a distance place, and chlorine must be injected into the water at the plant and controlled to maintain a certain range of concentration in the tank. However, concentration of chlorine declines with time elapsed for the transmission in accordance with many factors such as temperature, pH and total organic carbon of the raw water, etc. Therefore, the concentration in the tank may fluctuate even though it is stable at the plant; hence an intelligent control system that can stabilize the concentration in the tank is needed. Such a control system must be capable of forecasting the concentration at the distant place and controlling the injection rate to compensate for the fluctuation. One method to perform this control is using a neural network system (control system 10) that learns from previous process data and outputs the injection rate (via I/F device 20) to a controller (measurement controller 21) that controls a chemical injection device (control subject 22) according to current process data. The learning is achieved by optimizing internal parameters of the neural network; i.e. a nonlinear optimization.

According to the second embodiment, a processing program is provided with a search means based on the processing method for nonlinear optimization problems. As a result, an optimum solution can be calculated as the number of times of differential calculations and functional calculations carried out at one search step is reduced to the minimum. This enables machine control faster than conventional machine control.

### Third Embodiment

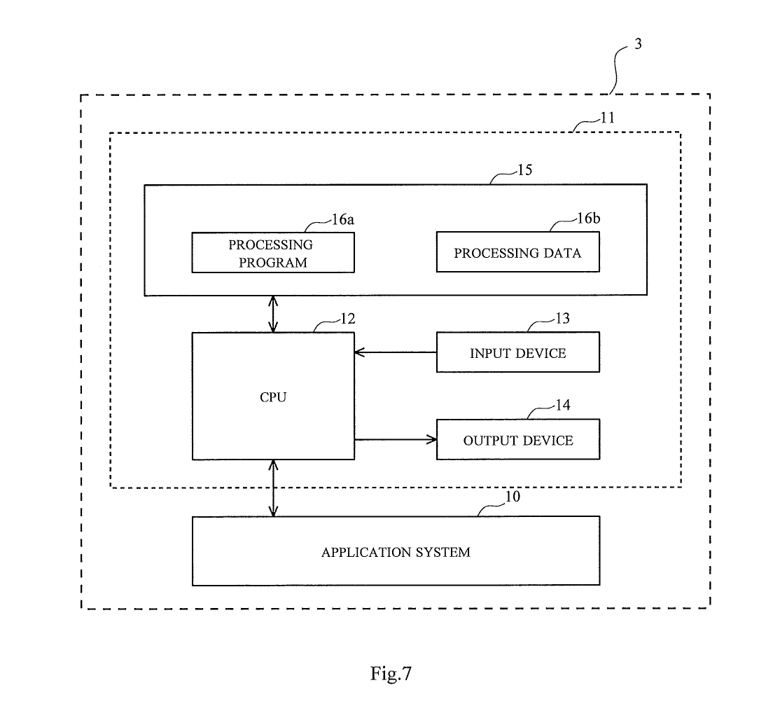

A hardware configuration of another embodiment of a processing system 3 that performs nonlinear optimization is illustrated in FIG. 7. The processing system 3 uses the above described processing method for nonlinear optimization problems. Constituent elements basically the same as constituent elements described in the first and second embodiments are denoted by the same reference numerals and are therefore omitted in further description.

The processing system 3 includes the CPU 12, the input device 13, the output device 14, the memory 15, the processing program 16a, the processing data 16b, and an application system 10 that use outputted value from the CPU 12. The processing program 16a and processing data 16b are stored in the memory 15. The programs and data for processing system 3 and application system 10 reside in suitable memory. In this embodiment, the CPU 12 can be part of a computer that is separate from the memory 15. In this embodiment, the application system 10 can be separate from a computer 11. Alternatively, the application system 10 can be part of the same computer (computer 11) containing the CPU 12.

An application system 10 can be any system that can utilize the output x from the CPU 12. For example, the application system 10 can be a control simulation system, a solver system, a machine learning system, an artificial neural network, a recognition system, a forecasting system, an automatic operation system, an automatic driving system, a control system, or any other system described or contemplated herein that can utilize the output x from the CPU 12.

According to the line search method, the step size α can be calculated with precision bearing comparison with the precision of the conventional line search based on the parabolic interpolation method and a gradient at a critical point at each search step can be approximated. When a large-scale nonlinear optimization problem is processed, in particular, the calculation time T for the processing can be reduced significantly.

According to the processing method for nonlinear optimization problems, a functional value at a critical point at each search step can be approximated. Asa result, the functional value at the critical point that must be calculated directly in the conventional case can be calculated recursively based on an already calculated value. Hence the calculation time T required for processing a nonlinear optimization problem can be reduced significantly.

The embodiments described herein provide a processing system such as solver system such as numerical analysis system, operations research system, structural calculation system, design simulation system and analysis system of fluid, heat, electromagnetic waves, etc., and many other computer systems such as control system, and a processing program that perform solver algorithms, machine learning methods, supervised learning methods for artificial neural networks, numerical analysis, operations research, structural calculation, design, simulation, and analyses of fluid, heat, electromagnetic waves, etc. with a processing speed improved to be significantly higher than a processing speed in the conventional case.

The embodiments described herein can be implemented in machine learning systems including, but not limited to, artificial neural networks; and applications that are implemented in conjunction with machine learning systems and/or artificial neural networks such as face recognition systems, automatic operation systems including, but not limited to, an automatic pilot system of an aircraft, an automatic driving system of an automobile, an automatic piloting system of a ship, and other automatic operation systems, demand forecasting systems used to predict future demand for a product and/or service, and the like.

Embodiments also include computer program products for performing various operations disclosed herein. The computer program products comprises program code that may be embodied on a computer-readable medium, such as, but not limited to, any type of disk including hard disks, floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions. One or more parts of the program code may be distributed as part of an appliance, downloaded, and/or otherwise provided to a user.

1. A method of increasing the processing speed of a computer having a computer processing unit that executes a non-linear optimization routine, comprising:
the computer processing unit executing a plurality of search steps to improve a vector x so that x minimizes or maximizes a value of a function of x, f (x), each search step includes:
a) assigning a vector g a gradient of f(x);
b) using g to determine a search direction vector, determining a step size, and changing x by using the determined search direction vector and step size;
c) using g and the determined search direction vector and step size to approximate a gradient of f(x);
d) determining if f(x) is close to a minimum or a maximum by using a convergence criterion;
e) if f(x) is not close to the minimum or the maximum, assigning the gradient of f(x) to g and returning to step b);
f) if f (x) is close to the minimum or the maximum, outputting x from the computer processing unit.

2. The method of claim 1, wherein outputting x from the computer processing unit comprises outputting x to an application system.

3. The method of claim 1, wherein outputting x from the computer processing unit comprises outputting x to a control simulation system, a solver system, a machine learning system, an artificial neural network, a recognition system, a forecasting system, an automatic operation system, an automatic driving system, or to a control system.

4. The method of claim 1, wherein the computer processing unit comprises computer hardware that executes programmed instructions.

5. The method of claim 1, wherein the computer processing unit comprises one or more of a single core central processing unit, a multi-core processing unit, a graphical processing unit, and a computer cluster.

6. A processing system that performs non-linear optimization with increased processing speed, comprising:
a computer having memory and a computer processing unit connected to the memory;
the memory storing therein a non-linear optimization program that is executed by the computer processing unit for causing the computer to execute a plurality of search steps to improve a vector x so that x minimizes or maximizes a value of a function of x, f(x), each search step includes:
a) assigning a vector g a gradient of f(x);
b) using g to determine a search direction vector, determining a step size, and changing x by using the determined search direction vector and step size;
c) using g and the determined search direction vector and step size to approximate a gradient of f(x);
d) determining if f(x) is close to a minimum or a maximum by using a convergence criterion;
e) if f(x) is not close to the minimum or the maximum, assigning the gradient of f(x) to g and returning to step b);
f) if f (x) is close to the minimum or the maximum, outputting x from the computer processing unit.

7. The processing system of claim 6, wherein outputting x from the computer processing unit comprises outputting x to an application system.

8. The processing system of claim 6, wherein outputting x from the computer processing unit comprises outputting x to a control simulation system, a solver system, a machine learning system, an artificial neural network, a recognition system, a forecasting system, an automatic operation system, an automatic driving system, or a control system, all of which receive x from the computer processing unit.

9. The processing system of claim 6, wherein the computer processing unit comprises computer hardware that executes programmed instructions.

10. The processing system of claim 6, wherein the computer processing unit comprises one or more of a single core central processing unit, a multi-core processing unit, a graphical processing unit, and a computer cluster.

11. Anon-transitory computer readable medium having recorded thereon a non-linear optimization program that is executable by a computer processing unit of a computer for causing the computer to execute a plurality of search steps to improve a vector x so that x minimizes or maximizes a value of a function of x, f(x), where each search step includes:
a) assigning a vector g a gradient of f(x);
b) using g to determine a search direction vector, determining a step size, and changing x by using the determined search direction vector and step size;
c) using g and the determined search direction vector and step size to approximate a gradient of f(x);
d) determining if f(x) is close to a minimum or a maximum by using a convergence criterion;
e) if f(x) is not close to the minimum or the maximum, assigning the gradient of f(x) to g and returning to step b);
f) if f (x) is close to the minimum or the maximum, outputting x from the computer processing unit.

12. The non-transitory computer readable medium of claim 11, outputting x from the computer processing unit comprises outputting x to an application system.

13. The non-transitory computer readable medium of claim 11, outputting x from the computer processing unit comprises outputting x to a control simulation system, a solver system, a machine learning system, an artificial neural network, a recognition system, a forecasting system, an automatic operation system, an automatic driving system, an automatic driving system, or to a control system.

14. The non-transitory computer readable medium of claim 11, wherein the computer processing unit comprises computer hardware that executes programmed instructions.

15. The non-transitory computer readable medium of claim 11, wherein the computer processing unit comprises one or more of a single core central processing unit, a multi-core processing unit, a graphical processing unit, and a computer cluster.
